(19) United States
(12) Patent Application Publication
(10) Pub. No.: US 2013/0076608 A1
(43) Pub. Date: Mar. 28, 2013

(54) METHOD OF DRIVING LIQUID CRYSTAL DISPLAY ELEMENT AND LIQUID CRYSTAL DISPLAY ELEMENT DRIVING DEVICE

(71) Applicants: Mitsuhiro Shigeta, Osaka-shi (JP); Toshihisa Uchida, Osaka-shi (JP)

(72) Inventors: Mitsuhiro Shigeta, Osaka-shi (JP); Toshihisa Uchida, Osaka-shi (JP)

(73) Assignee: SHARP KABUSHIKI KAISHA, Osaka-shi, Osaka (JP)

(21) Appl. No.: 13/703,087

(22) PCT Filed: Jun. 3, 2011
(86) PCT No.: PCT/JP2011/062775

§ 371 Date: Dec. 10, 2012

(30) Foreign Application Priority Data
Jun. 24, 2010 (JP) 2010-143903

(51) Int. Cl. G09G 3/36

(52) U.S. Cl. CPC G09G 3/36
USPC 345/87

(57) ABSTRACT

A method of driving a liquid crystal panel includes setting a gradation voltage corresponding to each gradation level with using a setting gamma function, and selecting the gradation voltage from a group of gradation voltages corresponding to a gradation level of the signal with using a selecting gamma function. A gamma value of the setting gamma function is different from a gamma value of the selecting gamma function. According to the driving method, if the gradation voltage that easily causes tailing or an image failure and the gradation voltage that hardly causes tailing or an image failure are applied to the display according to the gradation level of the input data signal, the gamma value of the setting gamma function is adjusted and unevenness is less likely to be caused by the gradation voltage. Accordingly, tailing or an image failure is less likely to occur.

### TECHNICAL FIELD

The present invention relates to a method of driving a liquid crystal display element and a liquid crystal display element driving device, and especially relates to a technology of effectively setting a gradation voltage that is applied to the liquid crystal display element and driving the liquid crystal display element in inputting a signal and displaying the liquid crystal display element.

### BACKGROUND ART

High-performance liquid crystal display devices such as large screen televisions have been used widely and such liquid crystal display devices have advantages in a light weight, small power consumption, and small heat radiation compared to cathode-ray tube monitors. Such high-performance liquid crystal display devices are used in various fields.

In displaying an image in a liquid crystal display device, a gradation level of an image signal that is input from an external device is converted to a gradation voltage with using a gamma function having a gamma value selected various gamma values, and the gradation voltage is applied to the liquid crystal display element. Such a technology is disclosed in Document 1. The gamma value that corresponds to the characteristics of the liquid crystal display element is selected from the various gamma values. Therefore, an image corresponding to the image signal is reproduced precisely with using the liquid crystal display element.

### [Patent Document 1] Japanese Unexamined Patent Publication No. 2005-172882

### Problem to be Solved by the Invention

However, even if an image is displayed with using the gamma function corresponding to the characteristics of the liquid crystal display element, tailing or an image failure in a moving image may be likely to occur. If the gamma value corresponding to the characteristics of the liquid crystal display element is selected, the gradation voltage that is to be applied to the liquid crystal display element is determined based on the selected gamma value. Therefore, according to the characteristics of the liquid crystal display element, voltage levels may be set densely in a gradation voltage area corresponding to one gradation level and voltage levels may be set roughly in a gradation voltage area corresponding to another gradation level. In such a case, in the gradation voltage area in which the voltage levels are roughly set, a voltage level that is to be selected may be between voltage levels that can be selected. This may cause tailing or an image failure in moving images.

### DISCLOSURE OF THE PRESENT INVENTION

The present technology was accomplished in view of the above circumstances. It is an object of the present technology to provide a technology in which tailing or an image failure is less likely to be caused in the liquid crystal display element.

### Means for Solving the Problem

To solve the above problem, a method of driving a liquid crystal display element according to an input signal includes setting a gradation voltage corresponding to each gradation level with using a setting gamma function and generating a group of gradation voltages, and selecting one of the gradation voltages from the group of gradation voltages corresponding to a gradation level of the signal with using a selecting gamma function. A gamma value of the setting gamma function is different from a gamma value of the selecting gamma function.

According to the present technology, the gamma value of the setting gamma function is different from the gamma value of the selecting gamma function. Therefore, even if the gamma value of the selection gamma function is determined automatically by the characteristics of the liquid crystal display element, the gamma value of the setting gamma function is freely set to a desired value. If the gradation voltage that easily causes tailing or an image failure and the gradation voltage that hardly causes tailing or an image failure are applied to the display according to the gradation level of the input signal, the gamma value of the setting gamma function is adjusted and unevenness is less likely to be caused by the gradation voltage.

The gamma value of the setting gamma function is preferably greater than the gamma value of the selecting gamma function. With this configuration, if tailing or an image failure is likely to occur on a low gradation side, tailing or an image failure is less likely to occur.

The gamma value of the setting gamma function is preferably smaller than the gamma value of the selecting gamma function. With this configuration, if tailing or an image failure is likely to occur on a high gradation side, tailing or an image failure is less likely to occur.

The signal may change a gradation level from a gradation level A to a gradation level B. The gradation level A is a gradation level before changing and the gradation level B is a target to be reached. A voltage corresponding to the gradation level A is a voltage VA, a voltage corresponding to the gradation level B is a voltage VB, and a voltage corresponding to a gradation level C of an overshoot signal is a voltage VC. The selecting step may preferably include converting the signal to an overshoot signal with which the gradation level changes from the gradation level A, the gradation level C to the gradation level B in this order, and selecting the voltage VC from the group of gradation voltages. The voltage VC is preferably applied to the liquid crystal display element as an overshoot voltage with which the gradation voltage changes from VA, VC to VB in this order according to the overshoot signal.

The overshoot signal is usually used for double-speed or quad-speed drive that requires high-speed response or time-division drive corresponding to 3D display. With such a driving method, overshoot voltage corresponding to the overshoot signal is applied to a liquid crystal display element and this improves response speed of the liquid crystal display element. However, tailing or an image failure is likely to occur in such driving compared to driving without using an overshoot signal. In the method of driving a liquid crystal display element of the present technology, a voltage VC corresponding to a gradation level C of the overshoot signal is selected from the voltage values of the gradation voltage. Therefore, in such driving using the overshoot signal, tailing or an image failure is less likely to occur.

The method may further include storing a group of gradation levels of the overshoot signal that is generated in first time that is prior to second time in which the selecting step is carried out. The gradation level C of the overshoot signal in the second time is preferably determined based on the group of gradation levels. Accordingly, the overshoot signal of the second time or the gradation voltage is provided with feedback from a result of the first signal that is generated in the first time. Accordingly, the gradation level in the second time is selected with considering environmental conditions such as temperature or humidity in the first time.

A number of bits of first data storing the group of gradation levels is preferably smaller than a number of bits of second data that is required for generating the overshoot signal. This reduces a storing capacity required for storing the first data.

Another aspect of the present technology is a liquid crystal display element driving device as follows. A driving device includes a setting part configured to set a gradation voltage corresponding to each gradation level with using a setting gamma function and generate a group of gradation voltages, and a selecting part configured to select one of the gradation voltages from the group of gradation voltages corresponding to a gradation level of the signal with using a selecting gamma function. A gamma value of the setting gamma function is different from a gamma value of the selecting gamma function.

With such a driving device, the above driving method is achieved and tailing or an image failure is less likely to occur.

### Advantageous Effect of the Invention

According to the present invention, tailing or an image failure is less likely to be caused in a liquid crystal display element.

### BRIEF DESCRIPTION OF THE DRAWINGS

FIG. 1 is a block diagram illustrating a configuration of a liquid crystal display device 10;

FIG. 2 is a block diagram illustrating a configuration of a setting part 34;

FIG. 3 is a graph illustrating a selection gamma function G1 and a setting gamma function G2;

FIG. 4 is a graph according to a related art;

FIG. 5 is a block diagram illustrating a configuration of a liquid crystal display device 110;

FIG. 6 is a look up table (LUT);

FIG. 7 is a graph illustrating an overshoot signal;

FIG. 8 is a block diagram illustrating a configuration of a liquid crystal display device 210;

FIG. 9 is a block diagram illustrating first data D1 and second data D2;

FIG. 10 is a graph illustrating overdrive errors; and

FIG. 11 is a graph illustrating overdrive errors according to a related art.

### BEST MODE FOR CARRYING OUT THE INVENTION

### First Embodiment

A first embodiment of the present invention will be described with reference to the drawings.

### 1. Configuration of Liquid Crystal Display Device

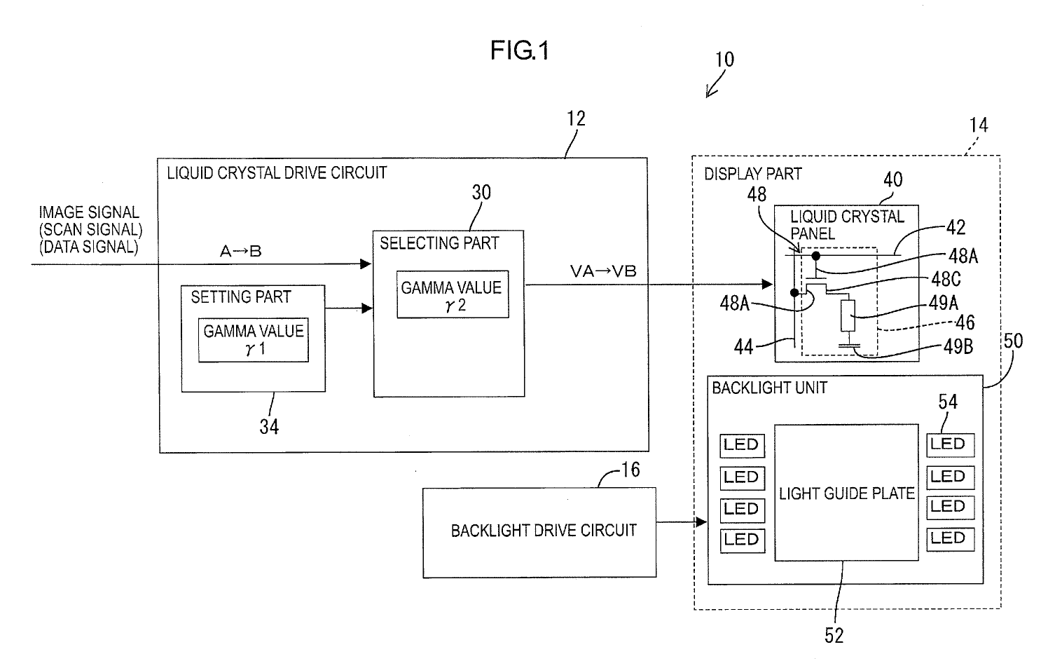

As illustrated in FIG. 1, a liquid crystal display device 10 includes a liquid crystal drive circuit 12 (an example of a driving device), a display part 14, and a backlight drive circuit 16. The display part 14 includes a liquid crystal panel 40 (an example of a liquid crystal display element) and a backlight unit 50.

The liquid crystal panel 40 includes scan lines 42, data lines and pixels 46. Each of the pixels 46 is a unit display element for driving the liquid crystal panel 40 and includes a switch device 48 and a pixel electrode 49A. The switch device 48 includes a switching electrode 48A and data electrodes 48B, 48C. The switching electrode 48A is connected to the corresponding scan line 42. The data electrode 48B is connected to the corresponding data line 44 and the data electrode 48C is connected to the pixel electrode 49. The pixel electrode 49 is arranged to face counter electrode 49B via liquid crystal molecules enclosed in the liquid crystal panel 40.

The backlight unit 50 is arranged on a rear-surface side of the liquid crystal panel 40. The backlight unit 50 includes LEDs (light emitting diodes) 54 that are light sources and a light guide plate 52. The LEDs 54 are arranged to face each side surface of the light guide plate 52. The light guide plate 52 is arranged such that a main surface thereof faces the liquid crystal panel 40. Light from the LEDs 54 enters the side surface of the light guide plate 52 and is guided into the light guide plate 52 to the main surface thereof facing the liquid crystal panel 40. Therefore, the side surface of the light guide plate 52 is a light entrance surface 52A through which the light from the LEDs 54 enters the light guide plate 52. The main surface of the light guide plate 52 is a light exit surface 52B from which the light traveling through the light guide plate 52 exits to the liquid crystal panel 40. Thus, the backlight unit 50 is a backlight unit of an edge-light type (a side-light type) that includes the LEDs 54 on each long-side edge and the light guide plate 52 in its middle portion.

The backlight drive circuit 16 is connected to the LEDs 54 that configure the backlight unit 50. The backlight drive circuit 16 supplies current to each of the LEDs 54 and controls a current amount supplied to each LED 54 to control an amount of light that enters the light guide plate 52 from each LED 54.

The liquid crystal drive circuit 12 drives the liquid crystal panel 40 based on image signals transmitted from an external device (not illustrated) . An image signal includes a scan signal and a data signal. The liquid crystal drive circuit 12 generates scan voltage based on the scan signal supplied from the external device and applies the scan voltage to the scan line 42 of the liquid crystal panel 40. The liquid crystal drive circuit 12 includes a circuit for setting a gradation voltage V that is input to the liquid crystal panel 40. The liquid crystal drive circuit 12 selects the gradation voltage V corresponding to the data signal that is supplied from the external device and applies the selected gradation voltage V to the scan line 42 of the liquid crystal panel 40. The image signal is supplied to the liquid crystal drive circuit 12 at every frame interval T that is determined according to a usage object of the liquid crystal panel 40. The liquid crystal drive circuit 12 executes the above process at every frame period T.

The liquid crystal drive circuit 12 includes a selecting part 30 and a setting part 34.

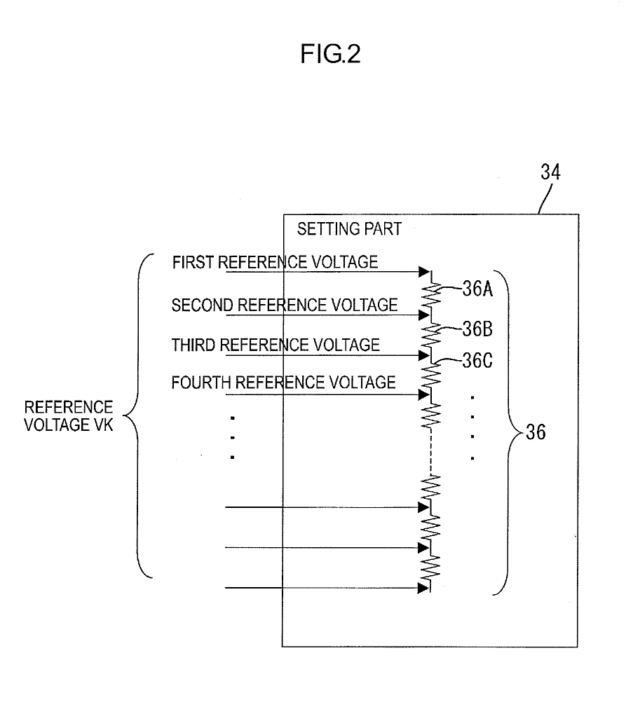

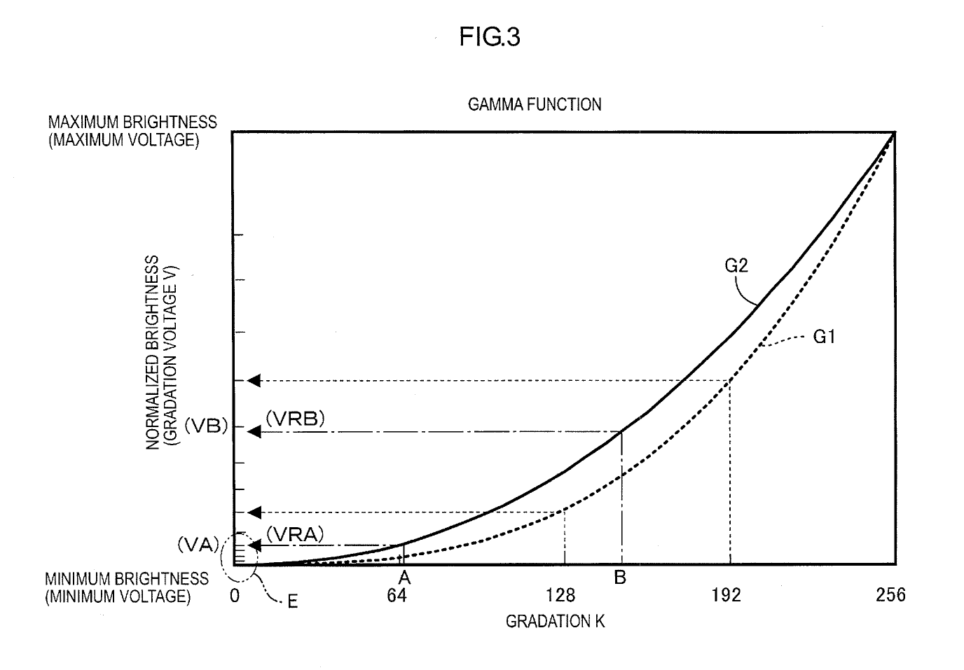

The setting part 34 sets a gradation voltage V. The setting part 34 corresponds to the circuit that sets the gradation voltage V. As illustrated in FIG. 2, the setting part 34 includes a resistance group 36 including a plurality of resistances (36A, 36B . . . ) that are connected in series and a plurality of reference voltages VK are input to the setting part 34 from an external power source (not illustrated). The setting part 34 divides the reference voltage VK by the resistance group 36 and sets a gradation voltage V (corresponds to a scale mark on a vertical axis in FIG. 3). Each resistance value of the resistances of the resistance group 36 is set by a designer. In the present embodiment, voltage values of gradation voltages each of which is set by the setting part 34 are set so as to achieve brightness characteristics of a gamma function G1 having a gamma value of γ1 (γ1=2.95) as illustrated by a dotted line in FIG. 3. The designer sets the resistance value of each of the resistances of the resistance group 36 so as to achieve the brightness characteristics of the setting gamma function G1. Accordingly, each of the gradation voltages V is set to a voltage value that corresponds to the brightness characteristics of the setting gamma function G1. Therefore, in the following explanation, the characteristics of the gradation level K and the brightness may be replaced with the characteristics of the gradation level K and the gradation voltage V.

The selecting part 30 stores a selection gamma function G2 having a gamma value of γ2 (γ2=2.2) and selects a gradation voltage V that is to be applied to the liquid crystal panel 40 with using the selection gamma function G2. The selecting part 30 is connected to the external device and if a gradation level K of the liquid crystal panel 40 before changing is a gradation level A and a target gradation level K is a gradation level B, a data signal designating that the gradation level K changes from the gradation level A to B is input to the selecting part 30. The selecting part 30 is connected to the setting part 34 and the gradation voltage K set by the setting part 34 is input to the selecting part 30. The selecting part 30 calculates ideal voltages VRA, VRB that are ideal voltages VR and each of which corresponds to the gradation level A and the gradation level B, respectively with using the selection gamma function G2 as illustrated by a dashed line in FIG. 3: The selecting part 30 selects a gradation voltage V that is close to each of the ideal voltages VRA, VRB as a gradation voltage VA and a gradation voltage VB each corresponding to the gradation level A and the gradation level B.

2. Display of Liquid Crystal Panel

If an image signal is input to the liquid crystal drive circuit 12 from an external device, the liquid crystal drive circuit 12 generates a scan voltage based on the scan signal included in the image signal and applies the scan voltage to the scan line 42 of the liquid crystal panel 40. The scan signal has voltage higher than a threshold voltage of the switch device 48 and accordingly, the switch device 48 is turned on. While the switch device 48 is on, the liquid crystal drive circuit 12 selects the gradation voltage VA and the gradation voltage VB from the data signal included in the image signal and applies the gradation voltages VA, VB to the data line 44 of the liquid crystal panel 40. The gradation voltages VA, VB are applied to the pixel electrode 49A via the switch device 48. Accordingly, the voltage of the pixel electrode 49A changes with respect to the counter electrode 49B, and according to the voltage change, the liquid crystal molecules arranged between the pixel electrode 49A and the counter electrode 49B are polarized and this changes transmission of the pixel 46. A polarization angle of the liquid crystal molecules in the pixel 46 changes according to the gradation voltage VA, VB that is applied to the scan line 42 and various transmission can be provided. The light exits from the light guide plate 52 and transmits through the pixels 46 that provide various transmission and this achieves different brightness by each of the pixels 46.

3. Advantageous Effects of the First Embodiment

In the present embodiment, the gamma value γ1 of the setting gamma function G1 that is used to set a gradation voltage V is set to a value different from the gamma value γ2 of the selection gamma function G2 used to select a gradation voltage V. Generally, the gamma value γ2 of the selection gamma function G2 is determined automatically by the characteristics of the liquid crystal panel 40 and cannot be changed. In the present embodiment, even if the gamma value γ2 of he selection gamma function G2 cannot be changed, the gamma value of the setting gamma function G1 is freely set to a desired value. According to the liquid crystal display device 10 of the present embodiment, if the gradation voltage V that easily causes tailing or an image failure and the gradation voltage V that hardly causes tailing or an image failure are applied to the display according to the gradation level K of the input signal, the gamma value γ1 of the setting gamma function G1 is adjusted and unevenness is less likely to be caused by the gradation voltage V. Accordingly, tailing or an image failure is less likely to occur in a wide range of the gradation level K.

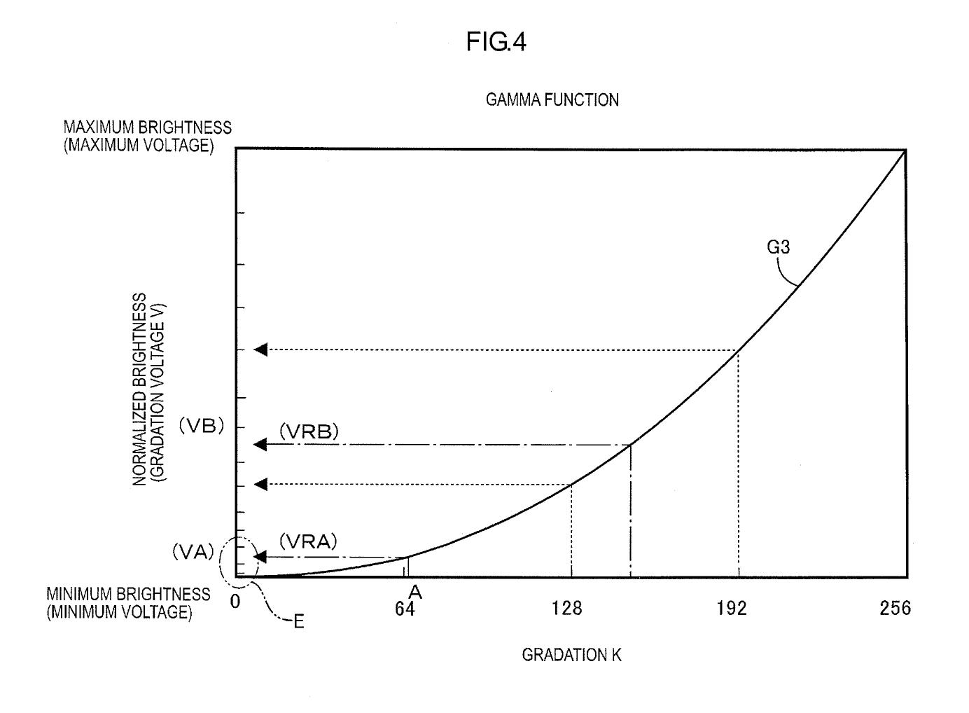

FIG. 4 illustrates a gamma function G3 of a related art for comparison with the present embodiment in FIG. 3. The gamma function G3 is commonly used for setting a gradation voltage V and selecting a gradation voltage V. A gamma value γ3 (γ3=2.2) of the gamma function G3 is automatically determined by the characteristics of the liquid crystal panel 40 and cannot be changed.

In the present embodiment, the setting gamma value γ1 is set to be greater than the selecting gamma value γ2, and a greater number of values of the gradation voltage V are set near a minimum voltage side compared to the conventional gradation voltage V (refer to E in FIGS. 3 and 4). Therefore, in selecting a gradation voltage V close to an ideal voltage VR on the minimum voltage side (for example the gradation level A), an absolute value of difference between the ideal voltage VR and the gradation voltage V becomes smaller compared to the conventional case. As a result, tailing or an image failure is less likely to occur due to difference between the ideal voltage and the gradation voltage V.

### Second Embodiment

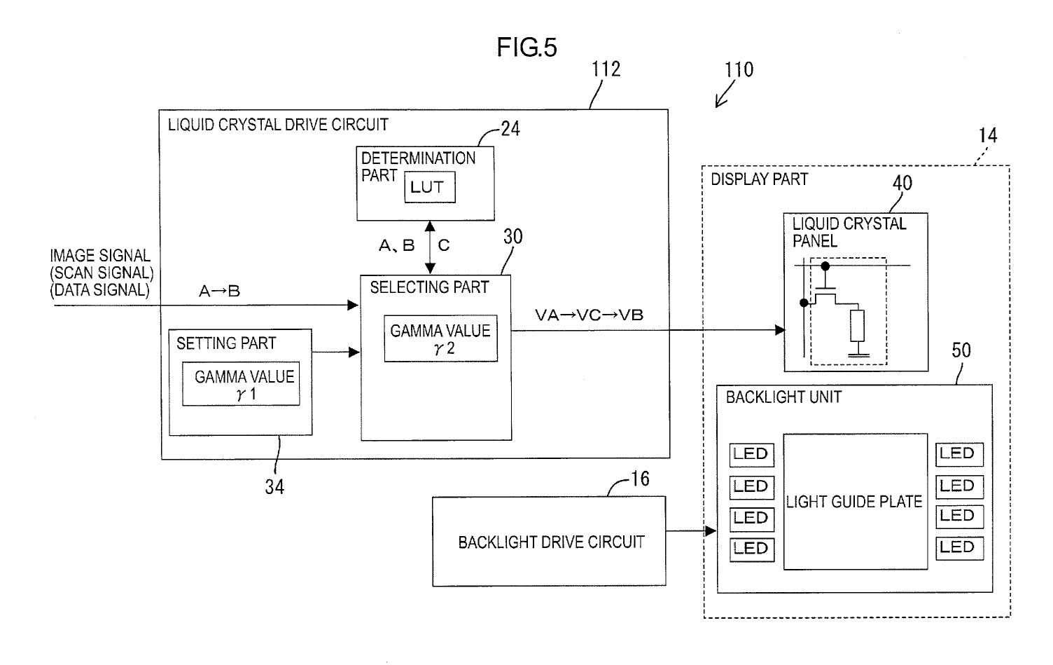

A second embodiment will be explained with reference to drawings. Unlike the liquid crystal display device 10 of the first embodiment, as illustrated in FIG. 5, in receiving an image signal from an external device, a liquid crystal drive circuit 112 of the second embodiment converts a data signal to an overshoot signal (OS signal) and applies a gradation voltage V according to the OS signal to the liquid crystal panel 40. Unlike the liquid crystal display device 10 of the first embodiment, the liquid crystal drive circuit 112 of the second embodiment includes a determination part 24 that determines a gradation level C that is an overshoot level of the OS signal. In the following explanation, components and operations same as those of the liquid crystal display device will not described.

1. Configuration of Liquid Crystal Drive Circuit

The liquid crystal drive circuit 112 includes the determination part 24, the selecting part 30 and the setting part 34.

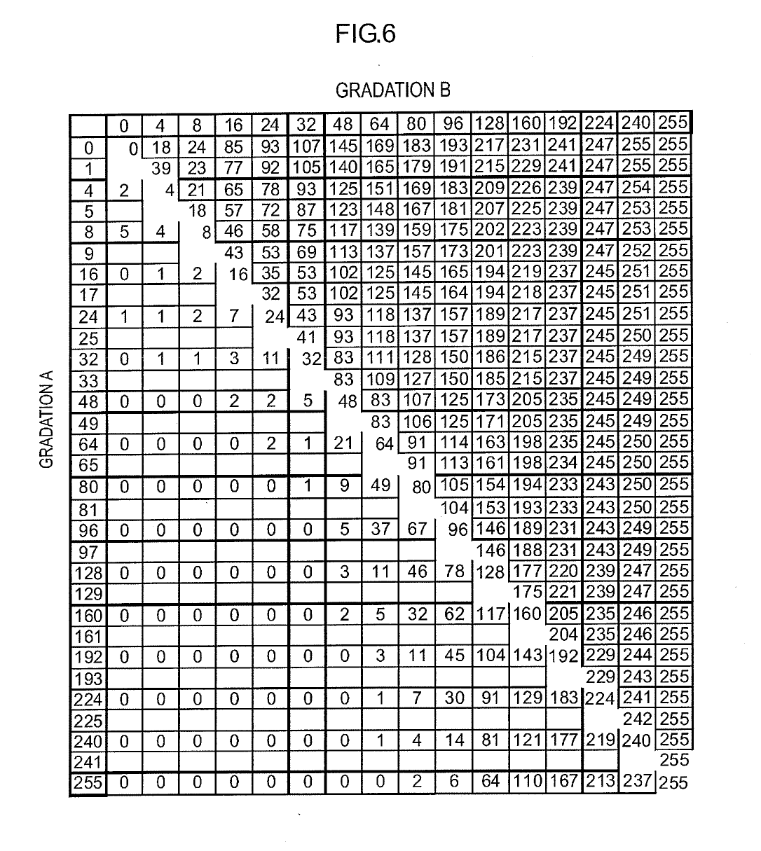

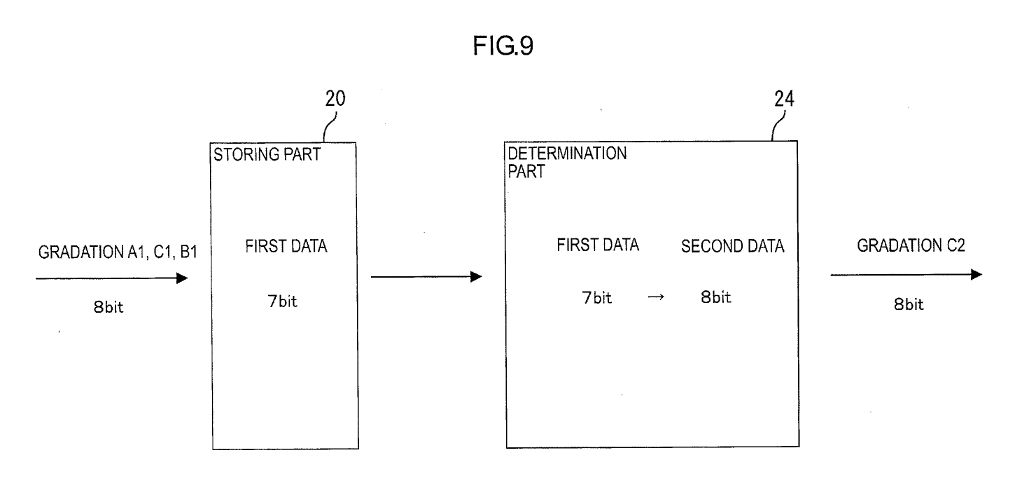

The determination part 24 includes a lookup table (LUT) and FIG. 9 illustrates the LUT. The LUT stores gradation levels C (parameters in a middle portion in FIG. 6) that correspond to combinations of the gradation levels A (a vertical line in FIG. 6) and the gradation levels B (a lateral line in FIG. 6). The gradation levels C stored in the LUT may be determined by previous measurement using the liquid crystal panel 40 that is to be actually used or may be determined by a simulation. The determination part 24 is connected to the selecting part 30 and obtains a combination of each of the gradation levels A, B from the external device and transmits a gradation level C that corresponds to the combination to the selecting part 30.

The selecting part 30 generates an overshoot signal based on the gradation levels A and B input from the external device and the gradation level C transmitted from the determination part 24. If the selecting part 30 receives a data signal representing that the gradation level rises from a gradation level A before changing to a target gradation level B, the selecting part 30 uses the gradation level C that is transmitted from the determination part 24 and has a gradation value higher than the gradation level B to convert the input data signal to an overshoot signal designating that the gradation level changes from A, B, to C in this order.

The selecting part 30 selects the gradation voltage VC that corresponds to the gradation level C from the voltage levels of the gradation voltage V that are set with using the setting gamma function G1 and applies to the data line 44 of the liquid crystal panel 40 an overshoot voltage (OS voltage) with which the gradation voltage V changes from VA, VC to VB in this order.

2. Advantageous Effects of the Second Embodiment

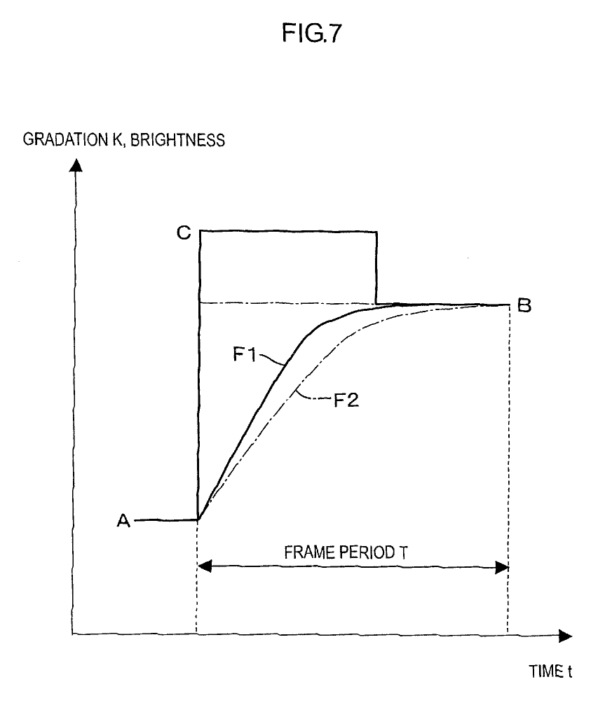

According to the second embodiment, the data signal input from the external device is converted to an OS signal and the liquid crystal panel 40 is driven by using an OD voltage corresponding to the OS signal. FIG. 7 illustrates a response waveform F1 (a solid line) using an OS signal and a response waveform F2 (a dashed line) without using an OS signal. If the liquid crystal panel 40 is driven with using an OS signal, time required for the liquid crystal panel 40 to reach target brightness is shortened. This improves response speed of the liquid crystal panel 40.

The OS signal is usually used for double-speed or quad-speed drive that requires high-speed response or time-division drive corresponding to 3D display. Accordingly, tailing or an image failure is likely to occur in such driving compared to driving without using an OS signal. In the liquid crystal display device 110 of the second embodiment, a voltage VC corresponding to a gradation level C of the OS signal is selected from the voltage values of the gradation voltage that are set with using the setting gamma function G1 having a gamma value different from the selection gamma function G2. Therefore, in such driving using the overshoot signal, tailing or an image failure is less likely to occur.

### Third Embodiment

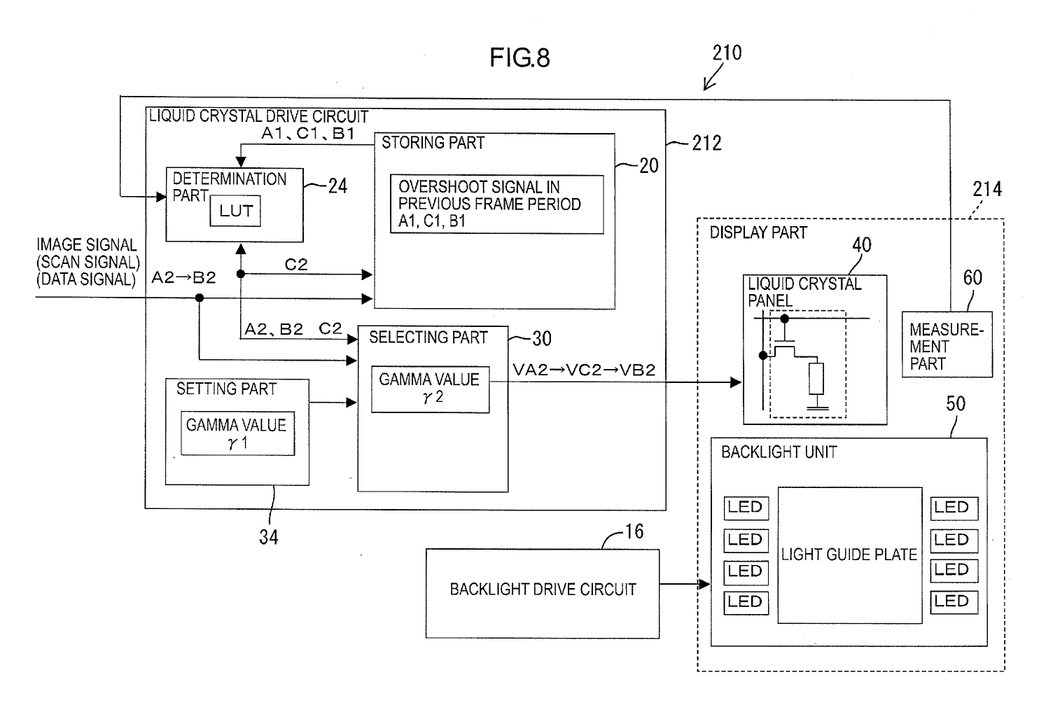

A third embodiment will be explained with reference to drawings. Unlike the liquid crystal display device 110 of the second embodiment, as illustrated in FIG. 8, a liquid crystal drive circuit 212 of the third embodiment includes a storing part 20 and a measurement part 60. Components and operations same as those of the liquid crystal display device 110 will not be described.

1. Configuration of Liquid Crystal Drive Circuit

The liquid crystal drive circuit 212 includes the storing part 20, the determination part, 24, the selecting part 30 and the setting part 34.

The storing part 20 stores a gradation group of an OS signal. Specifically, referring a previous frame period as T1 and a current frame period as T2, the storing part 20 stores the gradation levels A1, C1, B1 of the OS signal that is generated in the previous frame period T1. In FIG. 8, to distinguish the gradation level K and the gradation voltage V in the previous frame period T1 from those in the current frame period T2, the gradation level K related to the previous frame period T1 is referred to as a symbol with “1” (such as A1), and the gradation level K and the gradation voltage V related to the current frame period T2 are referred to as a symbol with “2” (such as A2, VA2).

The storing part 20 is connected to an external device and stores gradation levels A, B of the data signal input from the external device. The storing part 20 is connected to the determination part 24 and stores the gradation level C that is transmitted from the determination part 24 to the selecting part 30. The gradation level input from the external device or the storing part 20 is input to the storing part 20 and also input to the selecting part 30 and applied to the liquid crystal panel 40 as the gradation voltage V. Therefore, the storing part 20 already stores the gradation levels A1, C1, B1 of the OS signal in the previous frame period T1 that were used for driving the liquid crystal panel 40.

The determination part 24 is connected to the storing part 20 and reads the gradation level A1, C1, B1 stored in the storing part and sets the gradation level C2 of the LUT based on the gradation level A1, C1, B1. Specifically, the determination part 24 determines a parameter based on the gradation level C1 with reference to FIG. 6 in which the gradation level A in the vertical line is A1 and the gradation level B in the lateral line is B1. In the liquid crystal display device 210, the display part 214 includes the measurement part 60 and the measurement part 60 measures display characteristics of the liquid crystal panel 40 (such as a response waveform) or temperature or the like of the liquid crystal panel 40. The determination part 24 evaluates the gradation level C1 based on a measurement result that is obtained by the measurement part 60 in the previous frame period T1. For example, if the determination part determines that the gradation level C1 is appropriate, the gradation level C1 is set to the parameter of the corresponding part of the LUT. If the determination part does not determine that the gradation level C1 is appropriate, the gradation level C1 is changed and the changed value is set to the parameter of the corresponding part of the LUT.

As illustrated in FIG. 9, the OS signal is stored in the storing part 20 and the determination part 24. The storing part 20 stores the gradation values of the gradation level A1, C1, B1 that are input with eight bits from the external device or the determination part 24 as 7-bit first data D1 obtained by removing a least significant bit from the eight bits of the gradation values. The determination part 24 includes a conversion table. The determination part 24 receives the 7-bit first data D1 and converts the 7-bit first data D1 to 8-bit second data D2 with using the conversion table. The determination part 24 transmits the converted second data D2 to the storing part 20 and the selecting part 30 as the gradation level C2. The gradation levels A2, C2, B2 are input to the selecting part 30 as the 8-bit data and the selecting part 30 selects the gradation voltages VA2, VC2, VB3 with using such data having the number of bits greater than the first data D1 and applies the selected gradation voltages to the liquid crystal panel 40.

2. Advantageous Effects of the Third Embodiment

(1) In the third embodiment, the gradation level C2 of the overshoot signal in the current frame period T2 is determined based on the gradation levels A1, C1, B1 of the overshoot signal that is applied in the previous frame period T1. Namely, the overshoot signal of the current frame period T2 is provided with feedback from a result of the overshoot signal that is applied in the previous frame period T1. Accordingly, in second time, the gradation level C2 in the current frame period T2 is determined with considering the display characteristics or temperature in the current frame period T1, and accordingly, tailing or an image failure is less likely to occur.

(2) In the third embodiment, the gradation values of a signal input from an external device are stored in the storing part after reducing the number of bits of the signal. This reduces a storing capacity of the storing part and reduces a size of the liquid crystal drive circuit 212.

3. Experiment Results

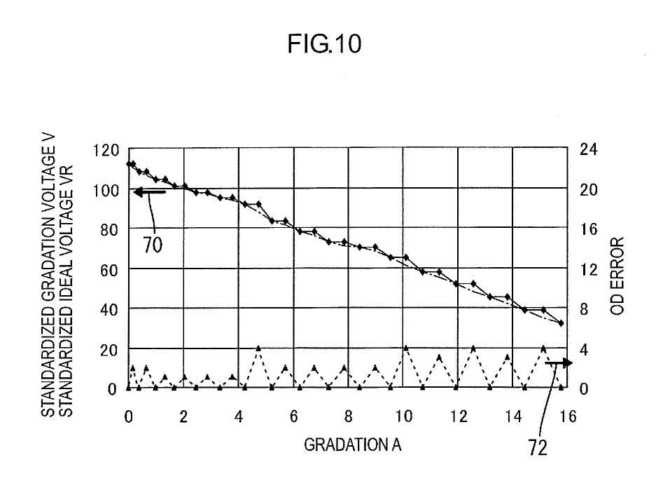

FIG. 10 illustrates experiment results of the third embodiment. In this experiment, in a case that the gradation level A2 before changing is set to a value from 0 to 16 and the target gradation level B2 is set to 16, the OS voltages are observed. In FIG. 10, a lateral line represents the gradation level A2 and a vertical line represents a voltage that is applied to the liquid crystal panel corresponding to the gradation level C2 of the OS signal. In FIG. 10, an ideal voltage VR corresponding to the gradation level C2 is represented by a dashed line and a gradation voltage V that is actually selected is represented by a solid line (refer to an arrow 70). An overshoot error (OS error) is represented by a dotted line, and the overshoot error is a difference voltage value between the ideal voltage VR and the selected gradation voltage V. Scales for the overshoot error are illustrated on a left vertical line (refer to an arrow 72).

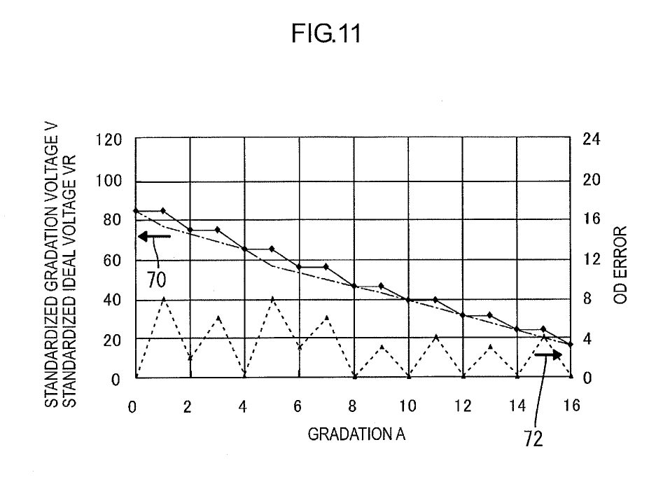

As a comparative example with the example of FIG. 10, FIG. 11 illustrates an ideal voltage VR, a gradation voltage V and an OS error according to a related art. In the third embodiment, the gamma value γ1 (γ1=2.95) is set to be greater than the gamma value γ2 (γ2=2.2), and compared to the related art (γ3=2,2), a greater number of voltage values of the gradation voltage V are set on the minimum voltage side. In the related art, as illustrated in FIG. 11, on the low gradation level side of the gradation level A, a same gradation voltage V is selected for the adjacent different gradation levels (such as “0” and “1” or “2” and “3”). Such a problem is less likely to occur in the present embodiment. Therefore, in the present embodiment, compared to the related art, it is confirmed that a gradation voltage V close to the ideal voltage VR is selected and the OD error is smaller on the low gradation level side.

### Other Embodiments

As describe above, the embodiments of the present invention have been described. However, the present invention is not limited to the above embodiments described in the above description and the drawings. The following embodiments are also included in the technical scope of the present invention, for example.

(1) In the above embodiments, the gamma value γ1 of the setting gamma function G1 is set to be greater than the gamma value γ2 of the selection gamma function G2. However, the gamma value γ1 may be set to be smaller than the gamma value γ2. If the gamma value γ1 is set to be smaller than the gamma value γ2, a greater number of voltage values can be set for the gradation voltage V on a maximum voltage side compared to the gradation voltage V of a related art. Therefore, in selecting a voltage value of the gradation voltage V close to the ideal voltage VR on the high gradation side, an absolute value of difference between the ideal voltage VR and the gradation voltage V can be smaller compared to a related art. As a result, tailing or an image failure is less likely to occur according to difference between the ideal voltage VR and the gradation voltage V.

(2) The gamma value γ2 of the selecting gamma function G2 is determined automatically by the characteristics of the liquid crystal panel 40, and the gamma value γ1 of the setting gamma function G1 can be set freely if necessary. Also, a difference value between the gamma value γ1 and the gamma value γ2 can be set freely if necessary. A difference value between the gamma value γ1 and the gamma value γ2 is preferably 0.3 or greater. If the difference value between the gamma value γ1 and the gamma value γ2 is 0.3 or greater, as illustrated in FIG. 10, the number of voltage values for the gradation voltage V on the low gradation side that can be selected increases by twice compared to the gradation voltage V of a prior art. In selecting a voltage value for the gradation voltage V close to the ideal voltage VR, difference between the ideal voltage VR and the gradation voltage V is reduced to be a half of that caused in a prior art.

(3) In the above embodiments, the liquid crystal panel 40 is a normally black panel in which a maximum voltage is applied in achieving maximum brightness. However, the relationship between brightness and voltage is not limited thereto. The present technology may be applied to a normally white liquid crystal panel in which a minimum voltage is applied in achieving maximum brightness. In such a case, the gamma value γ1 is set to be different from the gamma value γ2 and accordingly tailing or an image failure is less likely to occur.

(4) In the above embodiments, the LEDs are used as the light sources. However, light sources other than the LEDs may be used. The light sources are arranged to be the edge-light type. However, the light sources may be arranged on a rear-surface side of the light guide plate 52 and to be a direct type.

### EXPLANATION OF SYMBOLS

10: Liquid crystal display device,
12: Liquid crystal drive circuit,
14: Display part,
16: Backlight drive circuit,
20: Storing part,
24: Determination part,
30: Selecting part,
40: Liquid crystal panel,
42: Scan line,
44: Data line,
46: Pixel,
48: Switch device,
50: Backlight unit,
60: Measurement part

1. A method of driving a liquid crystal display element according to an input signal, the method comprising:
setting a gradation voltage corresponding to each gradation level with using a setting gamma function and generating a group of gradation voltages; and
selecting one of the gradation voltages from the group of gradation voltages corresponding to a gradation level of the signal with using a selecting gamma function, wherein
a gamma value of the setting gamma function is different from a gamma value of the selecting gamma function.

2. The method according to claim 1, wherein the gamma value of the setting gamma function is greater than the gamma value of the selecting gamma function.

3. The method according to claim 1, wherein the gamma value of the setting gamma function is smaller than the gamma value of the selecting gamma function.

4. The method according to claim 1, wherein
the signal changes a gradation level from a gradation level A to a gradation level B, the gradation level A being a gradation level before changing and the gradation level B being a target to be reached,
a voltage corresponding to the gradation level A is a voltage VA, a voltage corresponding to the gradation level B is a voltage VB, and a voltage corresponding to a gradation level C of an overshoot signal is a voltage VC, and
the selecting step includes:
converting the signal to an overshoot signal with which the gradation level changes from the gradation level A, the gradation level C to the gradation level B in this order; and
selecting the voltage VC from the group of gradation voltages, the voltage VC being applied to the liquid crystal display element as an overshoot voltage with which the gradation voltage changes from VA, VC to VB in this order according to the overshoot signal.

5. The method according to claim 4, further comprising:
storing a group of gradation levels of the overshoot signal that is generated in first time that is prior to second time in which the selecting step is carried out, wherein
the gradation level C of the overshoot signal in the second time is determined based on the group of gradation levels.

6. The method according to claim 5, wherein a number of bits of first data storing the group of gradation levels is smaller than a number of bits of second data that is required for generating the overshoot signal.

7. A liquid crystal display element driving device comprising:
a setting part configured to set a gradation voltage corresponding to each gradation level with using a setting gamma function and generate a group of gradation voltages; and
a selecting part configured to select one of the gradation voltages from the group of gradation voltages corresponding to a gradation level of the signal with using a selecting gamma function, wherein
a gamma value of the setting gamma function is different from a gamma value of the selecting gamma function.
